(19) United States
(12) Patent Application Publication
(10) Pub. No.: US 2026/0320557 A1
(43) Pub. Date: Oct. 15, 2026

(54) MESSAGING APPARATUS, SYSTEM, AND METHOD

(71) Applicant: Hitachi, Ltd., Tokyo (JP)

(72) Inventors: Kento NASU, Tokyo (JP); Shinichiro SAITO, Tokyo (JP)

(21) Appl. No.: 19/538,337

(22) Filed: Feb. 12, 2026

(30) Foreign Application Priority Data
Apr. 15, 2025 (JP) 2025-067016

(51) Int. Cl. G06Q 10/10; G06F 9/54

(52) U.S. Cl. CPC G06Q 10/10; G06F 9/541

(57) ABSTRACT

A Pub/Sub method messaging apparatus in which a message broker mediates a message between a message distributor and a message receiver has an offset-acquisition part for acquiring a message stored at the message broker, creating an index for the message, recording, as index-management information, association between the index and an offset of the message identified by the index, identifying the offset associated with the specified index by receiving the specified index from a user and by referring to the index-management information, and notifying the message receiver of the offset, which is an offset to be specified to the message broker, as the specified offset.

### CROSS-REFERENCE TO RELATED APPLICATIONS

This application is based upon and claims the benefit of priority from Japanese Patent Application No. 2025-067016 filed in Japan Patent Office on April 15, 2025, the contents of which are hereby incorporated by reference.

This disclosure relates to a Pub/Sub method messaging.

### BACKGROUND

A Pub/Sub (Publisher/Subscriber) method messaging service is widely provided in the cloud environment or on-premise.

The Pub/Sub messaging service is a messaging service which enables transmission/reception of a message by separating a message distributor and a message receiver from each other. The message distributor transmits a message with a topic serving as a transmission destination. The message receiver specifies a topic, for which a message is received, in advance. The message transmitted from the message distributor is queued for each topic at a message broker and is distributed to a message receiver who specified the topic concerned.

Japanese Translation of PCT Application No. 2003-524827 discloses a messaging queueing system other than the Pub/Sub method.

The message-queue management system disclosed in Japanese Translation of PCT Application No. 2003-524827 is a message-queue management system constituted to manage a plurality of queues including a first message queue of a first data-storage type and a second message queue of a second data-storage type indicating a consistent behavior throughout a plurality of computer media, wherein a journal state in which a journaled message is held in the first message queue and the second message queue is included, including: a journal module constituted to track and manage a message state of the messages stored in the first message queue and the second message queue; a one-time message processing module constituted to track a plurality of the message states so as not to re-process already processed messages stored in the first message queue and the second message queue; a compatible module constituted to adjust mutual actions between the plurality of queues which enable a distributed work flow; a recovery module constituted to execute data recovery of the plurality of queues at occurrence of a failure; a central management module constituted to provide concentrated control of the plurality of queues including control of a plurality of issuers and a plurality of participants; and a load-balance module constituted to specify a subset of the plurality of participants at least to the first message queue in a participant pool such that the message in the first message queue is processed by a first effective participant in the participant pool.

### SUMMARY

A user of the Pub/Sub messaging service may want to have a message receiver to receive a message after a specific message transmitted to a topic, rather than all the messages transmitted to the topic. For example, there is a case in which messages are to be received from among those arriving at the beginning of the month or from among those in which abnormality occurred. Concerning this, the general Pub/Sub messaging service has a function of receiving a message by specifying a latest message or an oldest message and of receiving a message subsequent to an arbitrary message by specifying an offset. However, the Pub/Sub messaging service does not have such a configuration that assumes a specific use in a user's system and thus, it is not easy for a user to specify a message to be used in the user's own system by offset of the Pub/Sub messaging service. In also the system of Japanese Translation of PCT Application No. 2003-524827, a function of selecting a message to be received in consideration of a specific use in the user's system is not provided.

An object included in this disclosure is to provide an art for facilitating selection and reception of a specific message in the Pub/Sub method messaging service.

A messaging apparatus according to an aspect of this disclosure is a Pub/Sub method messaging apparatus in which a message broker mediates a message between a message distributor and a message receiver, the apparatus including a subscriber part for acquiring from the message broker a message sent from the message distributor and stored at the message broker, an index-creation part for creating an index which makes identification of a desired message with respect to the acquired message possible and records, as index-management information, association between the index and the offset of the message identified by the index, and an offset-acquisition part for receiving the specified index, which is an index specified by the user, and for specifying the offset associated with the specified index by referring to the index-management information, and notifying the message receiver of the offset as a specified offset, which is an offset to be identified with respect to the message broker.

The messaging method according to another aspect of this disclosure is a messaging method executed by a message-receiver apparatus in the Pub/Sub method messaging apparatus in which a message broker mediates a message between a message distributor and a message receiver in the Pub/Sub method messaging, in which the message sent from the message distributor and stored at the message broker is acquired from the message broker, an index which enables identification of the desired message is created with respect to the acquired message, association between the index and the offset of the message identified by the index is recorded as index-management information, the specified index, which is the index specified by the user is received, and the index-management information is referred to, whereby the offset associated with the specified index is identified, and the offset is notified to the message receiver as the specified offset, which is an offset to be specified with respect to the message broker.

According to the aspect included in this disclosure, it becomes easy to select and receive a specific message in the Pub/Sub method messaging service.

### BRIEF DESCRIPTION OF THE DRAWINGS

FIG. 1 is a block diagram illustrating a constitution of a messaging system according to this Embodiment;

FIG. 2 is a block diagram illustrating a hardware configuration of a messaging apparatus according to this Embodiment;

FIG. 3 is a diagram illustrating an example of a message;

FIG. 4 is a diagram illustrating a display example of a GUI screen for registering an index-creation condition;

FIG. 5 is a diagram illustrating an example of index-management information;

FIG. 6 is a diagram illustrating another example of index-management information;

FIG. 7 is a diagram illustrating an example of index-creation processing; and

FIG. 8 is a diagram illustrating an example of index-deletion processing.

### DETAILED DESCRIPTION OF THE EMBODIMENT

Hereinafter, Embodiments of the present invention will be explained in detail with reference to the drawings.

### System Configuration

A messaging system according to this Embodiment is a messaging system which performs the Pub/Sub method messaging (hereinafter, also referred to as the Pub/Sub messaging), and a message broker mediates a message between a message distributor and a message receiver.

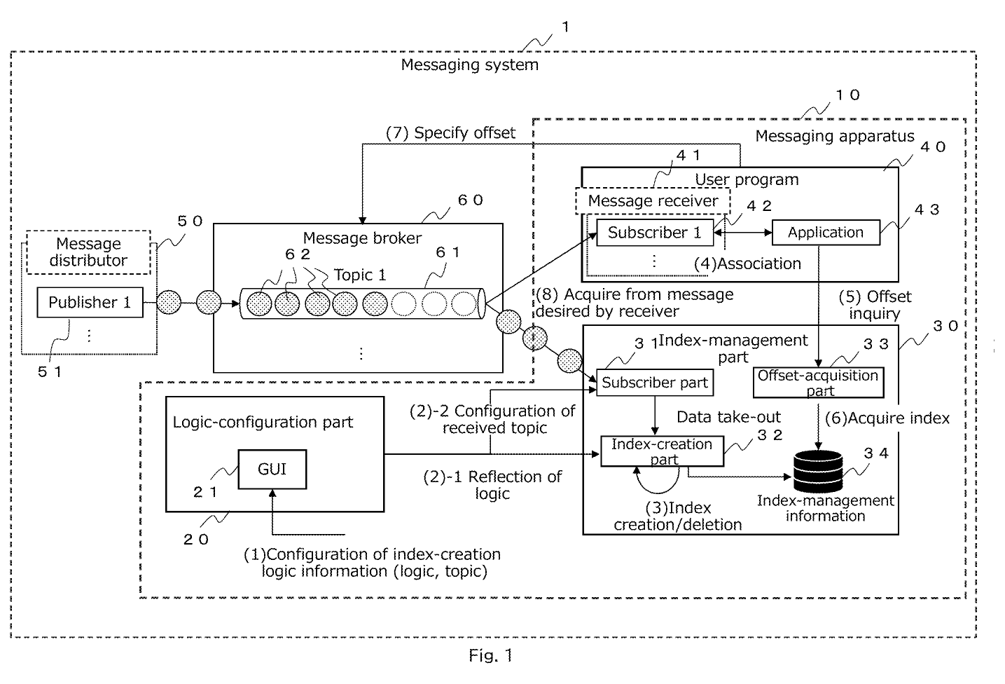

FIG. 1 is a block diagram illustrating a configuration of the messaging system. The messaging system 1 has a messaging apparatus 10, a message-distributor apparatus 50, and a message broker 60.

The message-distributor apparatus 50 is an apparatus on a message distributor side in the Pub/Sub messaging. The message broker 60 is a apparatus mediating a message in the Pub/Sub messaging.

In the message-distributor apparatus 50, a publisher 1 51 is mounted. The message-distributor apparatus 50 transmits a message toward a desired topic via the publisher 151. In an example in FIG. 1, a message 62 is transmitted to a topic 1. In the message broker 60, a queue 61 for each topic is constituted, and the message 62 transmitted to the topic is stored in the queue 61. In the example in FIG. 1, the message 62 of the topic 1 is stored in the queue 61. The message 62 is held in the queue 61 only for a predetermined time since it was stored, and the messaging apparatus 10 can acquire a message held in the queue 61. The held message 62 is stored in the queue 61 and then, deleted from the queue 61 after a predetermined time elapsed.

The messaging apparatus 10 is an apparatus on the message receiver side (message-receiver apparatus) in the Pub/Sub messaging. The messaging apparatus 10 in this Embodiment includes such a configuration that a user can easily identify and receive a desired message by giving an index which enables identification of the desired message to the message.

The messaging apparatus 10 has a logic-configuration part 20, an index-management part 30, and a user-program part 40. The logic-configuration part 20 has a GUI part 21. The index-management part 30 has a subscriber part 31, an index-creation part 32, and an offset-acquisition part 33. The user-program part 40 has a message-receiver apparatus 41 and an application 43. In the message-receiver apparatus 41, a subscriber 1 42 is mounted.

The logic-configuration part 20 configures index-creation logic information indicating a logic for creating an index in accordance with an input from a GUI (Graphical User Interface) provided by the GUI part 21. As the index-creation logic information, a topic for receiving the message 62 and a condition (logic) for creating an index are specified.

The index-management part 30 gives an index with a desired logic to the message 62 of the desired topic in accordance with the index-creation logic information and stores it as index-management information 34, and when an inquiry specifying the index from the user-program part 40 is made, an offset corresponding to the specified index is acquired from the index-management information 34, and a response is made.

The index-management part 30 has the subscriber part 31, the index-creation part 32, and the offset-acquisition part 33.

The subscriber part 31 acquires the message 62 from the queue 61 of the topic specified as the index-creation logic information. The index-creation part 32 creates an index in accordance with a creation condition specified by the index-creation logic information for the message 62 acquired by the subscriber part 31 and stores it in the index-management information 34 by associating the offset of the message with the index. The offset-acquisition part 33 receives an inquiry of the offset specifying the index from the user-program part 40, refers to the index-management information 34, and responds with the offset corresponding to the specified index to the user-program part 40.

The user-program part 40 has the message-receiver apparatus 41 and the application 43. In the message-receiver apparatus 41, the subscriber 1 42 is mounted. The application 43 is associated with the subscriber 142 of the message-receiver apparatus 41 and acquires the index indicating the message that the user desires to receive by inquiring of the index-management part 30. Then, the user-program part 40 specifies the acquired offset and acquires the message desired by the user from the message broker 60.

As described above, according to this Embodiment, since the index-management part 30 receives specification of the index from the user and notifies the offset corresponding to the index to the user, the user can easily select and receive a specific message in the Pub/Sub method messaging service.

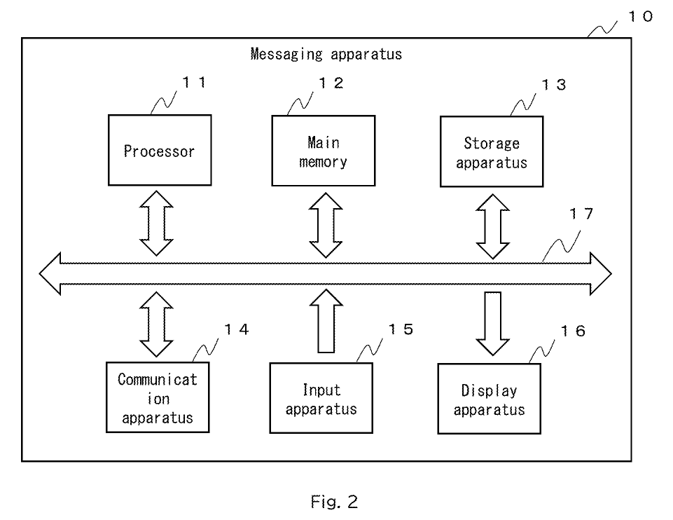

FIG. 2 is a block diagram illustrating a hardware configuration of the messaging apparatus. The messaging apparatus 10 has a processor 11, a main memory 12, a storage apparatus 13, a communication apparatus 14, an input apparatus 15, and a display apparatus 16, and these configuration elements are computers mutually connected via a bus 17.

The storage apparatus 13 includes a non-volatile storage apparatus such as an HDD (Hard Disc Drive), an SSD (Solid State Drive) or the like, and various types of management information including the index-management information 34 and a software program are stored therein. The processor 11 is an arithmetic apparatus such as a CPU (Central Processing Unit) and/or a GPU (Graphics Processing Unit) which executes processing of the software program. When the processor 11 executes the software program of various types of processing on the main memory 12 on the basis of the management information on the storage apparatus 13, each of the functions of the logic-configuration part 20, the index-management part 30, and the user-program part 40 in the messaging apparatus 10 is realized. The communication apparatus 14 is for connection to the other apparatuses such as the message broker 60 or the like via the communication network such as the Internet, the Intranet, a LAN (Local Area Network), a WAN (Wide Area Network) and the like or wired connection such as a USB (Universal Serial Bus) and the like. The input apparatus 15 is an input apparatus for receiving various type of configuration information and can be constituted by a pointing device such as a keyboard, a mouse, and a joystick, a touch panel, a sound microphone, or an arbitrary combination of them, for example. The display apparatus 16 is a display apparatus for providing visual information to a user and displays a GUI screen for receiving various types of configuration information, a result of processing execution by the processor 11 and the like.

### Structure of Message

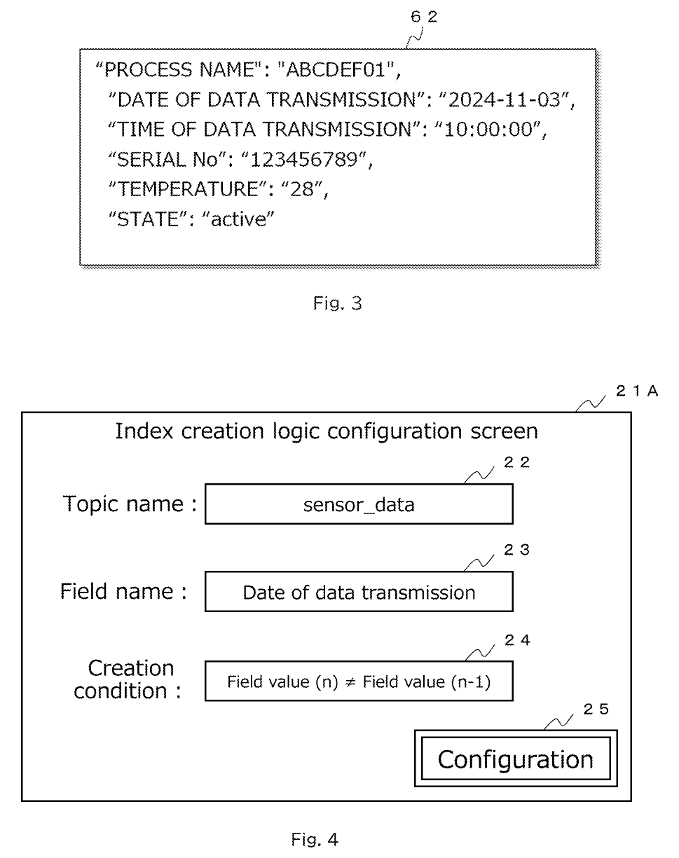

FIG. 3 is a diagram illustrating an example of a message. A message 62 is data including fields such as a process name, a date of data transmission, time point of data transmission, serial No., a temperature, a state and the like. In this example, the message 62 is a message notifying sensor data acquired by a temperature sensor installed in a plant. The process name is a name of a process performed in the plant when the sensor data was acquired. The date of data transmission is date information indicating a date when the message 62 was transmitted. The time point of data transmission is time-point information indicating a time point when the message 62 was transmitted. The serial No. indicates a serial number of the temperature sensor by which the data of the message 62 was measured. The temperature indicates temperature information indicating a temperature measured by the temperature sensor. The state indicates the state information indicating a state of the temperature sensor.

### Configuration of Index-Creation Logic

FIG. 4 is a diagram illustrating a display example of the GUI screen for configuring the index-creation logic. On a GUI screen 21A, an area 22 for configuring a topic name, an area 23 for configuring a field name, an area 24 for configuring a creation condition, and a configuration button 25 are displayed. When the user configures the topic name in the area 22, the field name in the area 23, and the creation condition in the area 24 and performs a pressing-down operation such as a mouse click or the like to configuration button, the logic-configuration part 20 creates index-creation logic information for creating an index by applying the creation condition configured in the area 24 with respect to a value of a field of the field name configured in the area 23 in the topic message having a topic name configured in the area 22. In FIG. 4, as an example, in the message of the topic whose topic name is sensor data, such an index-creation logic is to be configured that a value of a field whose name is a date of data transmission gives an index to a message with a value different from the value of the message one before. It has become possible to easily create a more preferable index for a configuration to which a logic is configured by an operation from the GUI.

It is to be noted that, here, such an example that the date of data transmission is configured as a field to be used for condition determination of the index-creation logic is illustrated, but another field can be configured as the field to be used for condition determination of the index-creation logic. For example, the field for a temperature illustrated in FIG. 3 may be made a field used for condition determination of the index-creation logic. And it may be configured such that an index is created by associating the index to the offset of the message whose field value satisfies a predetermined condition. For example, by defining a case where the temperature is 20ºC or less or a case where it is 40ºC or more as an abnormal state, such a condition may be configured that, when a temperature of 20ºC or less or 40ºC or more, it is defined as an abnormal state. As a result, by specifying acquisition of a message to which the index is added, reception by specifying the message notified as the abnormal state is made possible.

### Index-Management Information

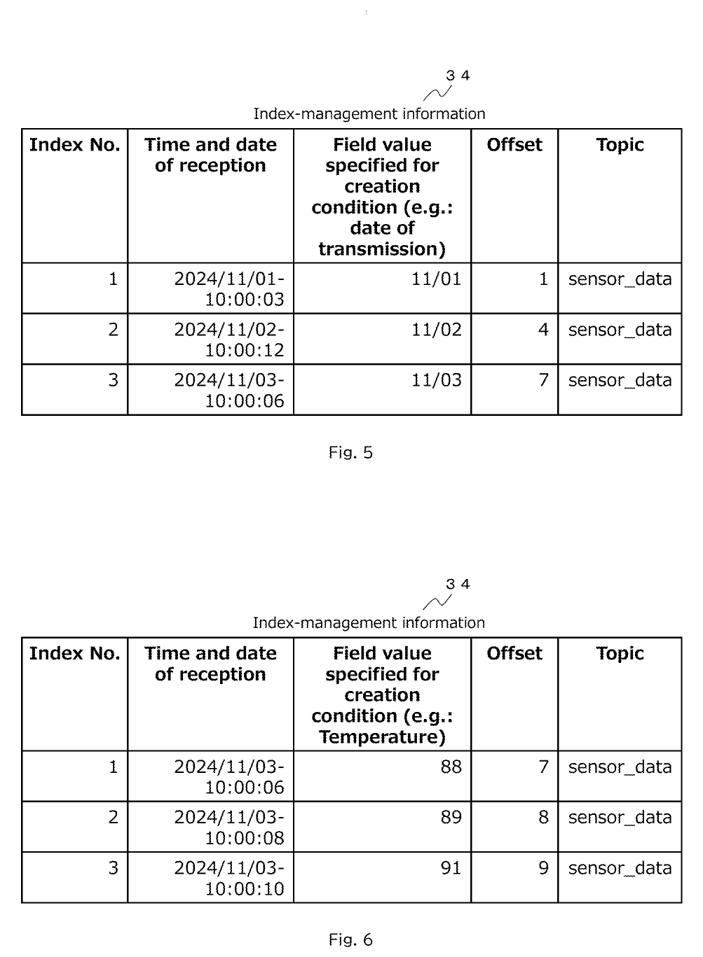

FIG. 5 is a diagram illustrating an example of the index-management information.

In the index-management information 34, for each of the created indexes, each of items of the index number, the time and date of reception, the field value specified in the creation condition, the offset, and the topic is registered in a table format. A table of the index-management information 34 may be created for each topic. In that case, an item of the topic may be omitted in the index-management information 34.

The index number is a number given to each index and enables unique identification of the index. The time and date of reception indicate time and date when the message for which the index was created was received by the message broker 60.

The field value specified for the creation condition is a value of a field used for the condition determination in the creation condition for creating the index. In the example in FIG. 5, the date of transmission when the publisher 151 transmitted the message for which the index was created, that is, the date of data transmission illustrated in FIG. 3 is used for the condition determination.

The offset is a value of the offset of the message for which the index was created. The offset is a serial number added to each message for each topic, for example. From the value of the offset, each message in the topic can be uniquely identified. The topic is an address specified when the publisher 151 transmits the message for which the index was generated.

By means of the configuration of the index-management information 34 as above, it becomes possible to identify the value of the offset for specifying a message for which reception is desired to the message broker 60 from the index which can be easily understood by the user.

FIG. 6 is a diagram illustrating another example of the index-management information. In FIG. 6, too, the index-management information 34 is registered with each of the items of the index number, the time and date of reception, the field value specified for the creation condition, the offset, and the topic in the table format for each of the created indexes. However, in the example in FIG. 6, differently from the example in FIG. 5, the information on the temperature stored in the message of which the index was created, that is, the temperature shown in FIG. 3 is used for the condition determination. For example, the index is created under such a creation condition that the index is created in a case of an abnormal state at such a temperature at 20ºC or less or at 40ºC or more.

### Index-Creation Processing

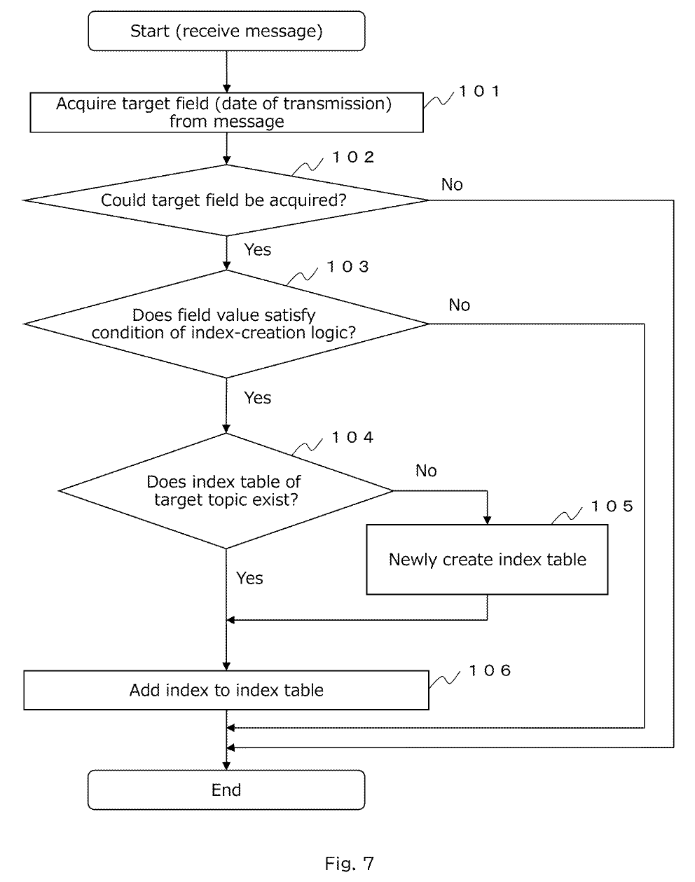

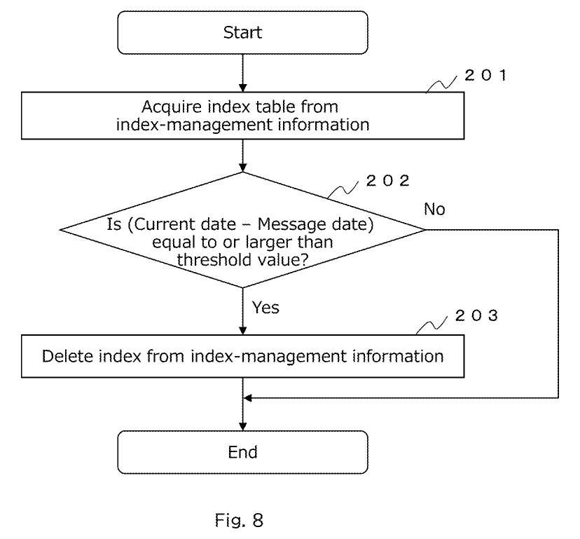

FIG. 7 is a flowchart illustrating an example of the index-creation processing.

The index-creation processing is started each time when a message is received. With reference to FIG. 7, first, when the subscriber part 31 receives a message, it acquires a target field from the received message (Step 101). In an example, the target field is a date of data transmission. Subsequently, the subscriber part 31 determines whether or not the value of the target field could be acquired (Step 102). If the value of the target field could not be acquired, the subscriber part 31 ends the processing as it is.

If the value of the target field could be acquired, the index-creation part 32 determines whether or not the field value satisfies a condition of the index-creation logic (Step 103). If the field value does not satisfy the condition, the index-creation part 32 ends the processing as it is. If the field value satisfies the condition, then, the index-creation part 32 determines whether or not the index table of the target topic exists (Step 104).

If the index table of the target topic does not exist, the index-creation part 32 newly creates an index table of the target topic (Step 105). When the index table of the target topic exists at Step 104 or when a new index table of the target topic was created at Step 105, the index-creation part 32 adds an index to the index table of the target topic (Step 106) and ends the processing.

By means of this configuration, correspondence between the index and the offset is recorded for each topic in the index-management information 34 as exemplified in FIGS. 5 and 6. After that, the message receiver side can specify a message desired to be received by using the index.

For example, in a state where the index-management information 34 in FIG. 5 is created under a creation condition of the index as exemplified in FIG. 4, when a user specifies a message transmitted on Nov. 3, 2024 and after, a message with the offset value of 7 is specified from the messaging apparatus 10 to the message broker 60, and as a result, the message transmitted on Nov. 3, 2024 and after is received.

In addition, when a user specifies a message to which an index was given in a state where the index-management information 34 in FIG. 6 was created under the creation condition that the index is created when the temperature is 20ºC or less or when it is 40ºC or more, a message with any one of the offset values 7, 8, 9 is specified from the messaging apparatus 10 to the message broker 60, and as a result, messages after the message notifying an abnormal temperature are received.

### Index-Deletion Processing

FIG. 7 is a flowchart illustrating an example of the index-deletion processing. The index-deletion processing is executed regularly once a day for each index, as an example.

First, the index-creation part 32 acquires an index from the index-management information 34 (Step 201). And the index-creation part 32 calculates a difference between the current date and a date included in the time and date of reception of the message for which the index was created and determines whether or not the difference is equal to or larger than a predetermined threshold value (Step 202). If the difference is smaller than the threshold value, the index-creation part 32 ends the processing as it is. If the difference is equal to or larger than the threshold value, the index-creation part 32 deletes the index from the index-management information 34 (Step 203) and ends the processing. By means of this configuration, an unnecessary index for which time equal to or larger than the deletion threshold value has elapsed since creation is deleted, and an increase in a data amount on the database can be suppressed.

It is to be noted that this threshold value only needs to be configured on the basis of the time period since the message 62 is stored in the queue 61 until it is deleted from the queue 61. For example, the threshold value may be configured to the same time period as the time period since the message 62 is stored in the queue 61 until it is deleted from the queue 61.

The Embodiment of the present invention has been explained, but the present invention is not limited to the above-described Embodiment but is capable of various variations or changes. In addition, the Embodiment of the present invention includes the matters indicated below. However, the matters included in the Embodiment of the present invention are not limited only to those shown below.

### Matter 1

A Pub/Sub method messaging apparatus in which a message broker mediates a message between a message distributor and a message receiver has a subscriber part which acquires from the message broker a message sent from the message distributor and stored at the message broker, an index-creation part which creates an index which enables identification of a desired message with respect to the acquired message and records, as index-management information, association between the index and an offset of the message identified by the index, and an offset-acquisition part for receiving the specified index, which is the index specified by the user, and identifying an offset associated with the specified index by referring to the index-management information, and notifying the message receiver of the offset as a specified offset, which is the offset to be specified, to the message broker. As a result, since the specification of the index is received from the user, and the offset corresponding to the index is notified to the user, a specific message can be selected and received easily in the Pub/Sub method messaging service.

### Matter 2

In the messaging apparatus described in the Matter 1, a logic-configuration part for configuring index-creation logic information indicating a logic for creating an index is further provided, and the index-creation part creates an index in accordance with the index-creation logic information. As a result, a preferable index can be easily created by the logic configuration.

### Matter 3

In the messaging apparatus described in the Matter 1, the index-creation part deletes, from the index-management information, information on association in which an elapsed time since the index creation becomes equal to or larger than a predetermined threshold value. As a result, by deleting an unnecessary index for which time equal to or larger than the deletion threshold value has elapsed since the creation, an increase of a data amount on the database can be suppressed.

### Matter 4

In the messaging apparatus described in the Matter 2, the logic-configuration part configures, as the index-creation logic information, a field included in the message and a creation condition for the value of the field.

### Matter 5

In the messaging apparatus described in the Matter 4, the message distributor transmits a message toward a desired topic, the subscriber part acquires the message transmitted to the specified topic from the message broker, and the index-creation part records association between the index and the offset of the message for each of the topics.

### Matter 6

In the messaging apparatus described in the Matter 5, the logic-configuration part displays a screen including an area in which a topic to be an index creation target is to be configured, an area in which the field is to be configured, and an area for causing the creation condition to be configured, and creates the index-creation logic information on the basis of the topic that have been input to the screen, the field, and the creation condition. As a result, by configuring the topic to be the index creation target, the field, and the creation condition in accordance with the screen display, the index-creation logic information can be easily created.

### Matter 7

The messaging system has a messaging apparatus described in the Matter 1, the message distributor apparatus by which the message distributor transmits a message, and the message broker.

### Matter 8

In the messaging method executed by the message-receiver apparatus in the Pub/Sub method messaging in which the message broker mediates a message between the message distributor and the message receiver, a message sent from the message distributor and stored at the message broker is acquired from the message broker, an index which enables identification of a desired message is created with respect to the acquired message, association between the index and an offset of the message identified by the index is recorded as index-management information, the specified index, which is an index specified by the user, is received, and by referring to the index-management information, the offset associated with the specified index is identified, and the offset is notified to the message receiver as a specified offset, which is an offset to be specified with respect to the message broker.

What is claimed is:

1. A Pub/Sub method messaging apparatus in which a message broker mediates a message between a message distributor and a message receiver, the apparatus comprising:
a subscriber part for acquiring from the message broker a message sent from the message distributor and stored at the message broker;
an index-creation part for creating an index which enables identification of a desired message with respect to the acquired message, and records, as index-management information, association between the index and an offset of the message identified by the index, and
an offset-acquisition part for receiving the specified index, which is an index specified by the user, and for identifying the offset associated with the specified index by referring to the index-management information, and notifying the message receiver of the offset as a specified offset, which is an offset to be specified with respect to the message broker.

2. The messaging apparatus according to claim 1, further comprising:
a logic-configuration part for configuring index-creation logic information indicating a logic for creating an index, wherein
the index-creation part is configured to create an index in accordance with the index-creation logic information.

3. The messaging apparatus according to claim 1, wherein
the index-creation part is configured to delete, from the index-management information, information on association in which an elapsed time since the index creation becomes equal to or larger than a predetermined threshold value.

4. The messaging apparatus according to claim 2, wherein
the logic-configuration part configures, as the index-creation logic information, a field included in the message and a creation condition with respect to a value of the field.

5. The messaging apparatus according to claim 4, wherein
the message distributor is configured to transmit a message toward a desired topic;
the subscriber part is configured to acquire the message transmitted toward the specified topic from the message broker; and
the index-creation part is configured to record association between an index and an offset of the message for each topic.

6. The messaging apparatus according to claim 5, wherein
the logic-configuration part is configured to display a screen including an area for configuring a topic, which is to be an index-creation target, an area for configuring the field, and an area for configuring the creation condition, and creates the index-creation logic information on the basis of the topic, the field, and the creation condition that have been input to the screen.

7. A messaging system comprising:
the messaging apparatus according to claim 1;
a message-distributor apparatus by which the message distributor transmits a message; and
the message broker.

8. A messaging method executed by a message receiver apparatus in a Pub/Sub method messaging in which a message broker mediates a message between a message distributor and a message receiver, wherein
a message sent from the message distributor and stored at the message broker is acquired from the message broker;
an index which enables identification of a desired message is created with respect to the acquired message, association between the index and an offset of the message identified by the index is recorded as index-management information; and
by receiving the specified index, which is the index specified by the user, and by referring to the index-management information, the offset associated with the specified index is identified, and the offset is notified to the message receiver as the specified offset, which is an offset to be specified with respect to the message broker.
